(19) United States
(12) Patent Application Publication
(10) Pub. No.: US 2017/0353704 A1
(43) Pub. Date: Dec. 7, 2017

(54) Environment-Aware Supervised HDR Tone Mapping

(71) Applicant: Apple Inc., Cupertion, CA (US)

(72) Inventors: Yeping Su, Sunnyvale, CA (US); Chris Chung, Sunnyvale, CA (US); Hsi-Jung Wu, San Jose, CA (US); Xiaosong Zhou, Campbell, CA (US); Jun Xin, Sunnyvale, CA (US); Jun Xu, Cupertino, CA (US)

(21) Appl. No.: 15/611,636

(22) Filed: Jun. 1, 2017

Related U.S. Application Data
(60) Provisional application No. 62/344,295, filed on Jun. 1, 2016.

(51) Int. Cl. H04N 9/64; G06T 5/00; H04N 5/58

(52) U.S. Cl. CPC H04N 9/646; H04N 5/58; G06T 5/009; G06T 2207/20208

(57) ABSTRACT

Embodiments of the present disclosure provide techniques for environment aware supervised HDR tone mapping. According to those techniques, responsive to metadata provided with HDR source video data, the received metadata may be compared to sensor date representing viewing conditions at a display device. Tone mapping corrections to the HDR source video data may be derived from the comparison of the received metadata to the sensor data. The HDR source video data may be altered based on the tone mapping corrections. The altered HDR source video data may be used to drive the display device.

### CROSS REFERENCE TO RELATED APPLICATIONS

This application benefits from priority of application Ser. No. 62/344,295, filed Jun. 1, 2016 and entitled “Environment-Aware Supervised HDR Tone Mapping,” the disclosure of which is incorporated herein by its entirety.

### BACKGROUND

Color grading often involves enhancement of video content based on a predicted estimate of a reference viewing environment. Color grading does not consider actual circumstances of a viewing environment such as ambient lighting and viewing distance, which often results in unexpected results when the playback viewing environment is quite different from the reference environment. The viewing environments can be considered during playback without explicit information in metadata associated with source video but it is less optimal than when explicitly specified.

HDR (high dynamic range) video is often compared to SDR (standard dynamic range) video. HDR images often represent images with greater image content to reproduce a greater dynamic range of luminosity than is possible with SDR video. While HDR video tends to provide higher quality representations of image content at extremely bright and extremely dark ranges of luminosity, HDR video can look noticeably darker than SDR video when presented adjacent to each other.

For example, on a mobile device with maximum brightness of 350 nits, SDR video could look brighter than HDR video when the panel brightness is set to the maximum in a bright room. A 100-nit graded SDR video likely would be boosted to the maximum brightness, whereas HDR video likely would be down-mapped to the maximum brightness, resulting in an impression that SDR video often looks more pleasing. This problem can arise in a viewing environment that includes two displays, one showing HDR video and the other showing SDR video. Even though the HDR television can present much higher brightness, displayed HDR video may look darker depending on how grading is done and also how the playback viewing environment is considered during playback.

The inventors perceive a need in the art for a display technique that changes representations of HDR video to adapt them favorably for comparison favorably with SDR representations of the same video.

### BRIEF DESCRIPTION OF THE DRAWINGS

FIG. 1(a) and FIG. 1(b) show two use cases where juxtaposition of rendered HDR video and SDR video can show HDR under performance.

FIG. 2 illustrates a functional block diagram of a system having player device according to an embodiment of the present disclosure.

FIG. 3 illustrates a method according to an embodiment of the present disclosure.

FIG. 4 illustrates a method according to an embodiment of the present disclosure,

FIG. 5 illustrates a method according to an embodiment of the present disclosure.

FIG. 6 illustrates a computing device according to an embodiment of the present disclosure.

### DETAILED DESCRIPTION

Embodiments of the present disclosure provide techniques for environment aware supervised HDR tone mapping. According to those techniques, responsive to metadata provided with HDR source video data, the received metadata may be compared to sensor date representing viewing conditions at a display device. Tone mapping corrections to the HDR source video may be derived from the comparison of the received metadata to the sensor data. The HDR source video data may be altered based on the tone mapping corrections. The altered HDR source video data may be used to drive the display device. The inventors observe that such a technique, as well as others disclosed herein, may improve the visual quality of rendered HDR video.

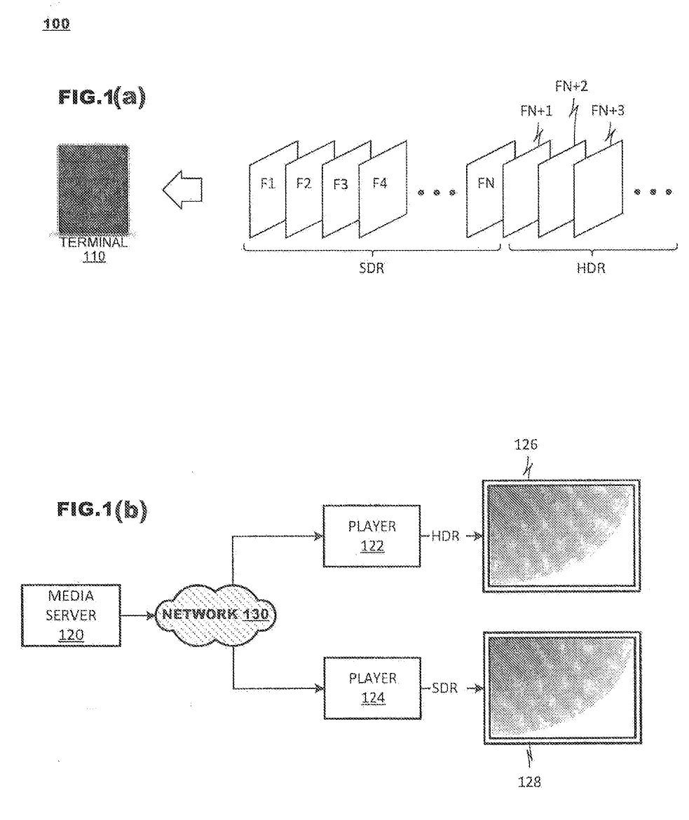

The principles of the present disclosure find application with a variety of use cases that cause HDR video and SDR video to he displayed in proximity with each other. Several use cases are illustrated in FIG. 1(a-b).

In FIG. 1(a), a terminal 110 renders SDR video 112 and HDR video 114 in temporal proximity to each other. For example, as illustrated in FIG. 1(a), the terminal 110 first may render SDR video frames F1-FN. Subsequently, the terminal 110 may render HDR video frames FN+1, FN±2, EN+3, and so forth. In some instances, the frames may comprise a common video content, such as a television program or a movie. While at other times, the SDR frames F1 through FN may comprise frames of one instance of video content and the HDR frames FN+1 through F1+3 may comprise an instance of other video content. For example, the SDR frame F1 through FN may comprise a portion of a television show or movie and the HDR frames FN+1 through FN+3 may comprise an advertisement or other supplemental content, or vice versa. Either way, the switch from SDR video 112 to HDR video 114 may be noticeable to a viewer if displayed on a terminal that applies a common brightness for display of both videos. As discussed, display of HDR video 114 on a terminal 110 at a brightness suitable for SDR video 112 may cause the HDR video 114 to appear overly dark.

In FIG. 1(b), a media server 120 transmits video content over a network 130 to a first player 122 and a second player 124. The first player 122 receives the video content and generates HDR video. The HDR video is transmitted to a first display 126 for rendering. The second player 124 receives the video content and generates SDR video, which is transmitted to a second display 128 for rendering. The first and second displays 126, 128 may be located in proximity to each other and may share common display attributes, such as a maximum brightness attribute. The underperformance of the rendering of the HDR video, relative to that of the SDR video, may be readily apparent to a viewer. The underperformance may be particularly evident if the HDR video and the SDR video contain common video content.

In some embodiments, the media server 120 may transmit HDR video to the player 122 and separately transmit SDR video to the player 124 As noted, the HDR video and the SDR video may comprise common video content. For example, the 11DR video may be an HDR copy of the SDR video or vice versa. In other embodiments, the media server 120 may transmit HDR copies of the common video content to both the player 122 and the player 124. The player 124 may down-convert the HDR, copy of the video content to SDR video for display on the second display 128. Alternatively, the media player 120 may transmit SDR copies of the common video content to both the player 122 and the player 124. The player 122 may then up-convert the SDR copy of the video content to HDR video for display on the first display 126.

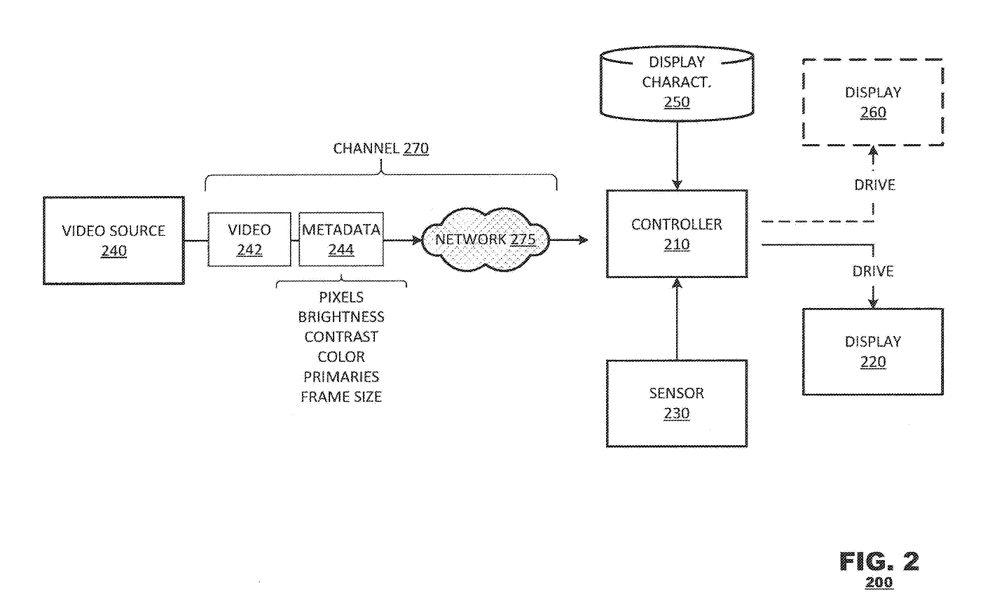

FIG. 2 illustrates a functional block diagram of a player system 200 according to an embodiment of the present disclosure. The player system 200 may include a controller 210, a display 220, a sensor 230, a video source 240, and a memory 250. The controller 210 may perform display mapping to condition HDR data for output on the display 220. The display 220 may render HDR video and, optionally, other video formats such as SDR video. The sensor 230 may detect ambient brightness levels in an area occupied by the display 220. The memory system 250 may store data representing characteristics of the display 220,

The controller 210 may generate video drive signals from source HDR data supplied by the video source 240. The video drive signals may tailor the HDR data for the characteristics of the display 220, which are described in the display characteristics memory 250, taking into account ambient brightness as reported by the sensor 230. Additionally, the controller 210 may alter its mapping operation based on consideration of SDR source data and/or characteristics of a second display 260, if provided to the player system 200, as described herein.

The video source 240 may be embodied in various forms. For example, the video source 240 may be a video content provider, such as a cable television provider. A video content provider also may comprise a digital video streaming service or other source of digital video data. The video source 240 alternatively may comprise a storage medium (e.g., a hard drive or other type of storage device) configured to store and provide video data. The storage medium may be incorporated or otherwise associated with a video player. In other instances, the video source 204 may include one or more cameras configured to capture video data. The one or more cameras likewise may be incorporated or otherwise associated with a video player,

The video source 240 may provide video 242 and metadata 244 to the controller 210. The video 242 may comprise HDR video and/or SDR video. As used herein, HDR video refers to video with a higher dynamic range than that of SDR video. The dynamic range referred to in HDR or SDR video may be with respect to luminance. The HDR video may conform to various HDR standards, such as HDR10 Media Profile or Dolby Vision. The HDR video further may conform to ITU-R Recommendation BT.2020 or ITU-R Recommendation BT.2100, also known as Rec. 2020 and Rec. 2100, respectively. The SDR video may conform to ITU-R Recommendation BT.601 or ITU-R Recommendation BT.709, which are also referred to as Rec. 601 and Rec. 709, respectively.

The metadata 244 may comprise HDR and/or SDR metadata and may be transmitted in association with the video 242 or embedded with the video 242. The metadata 244 may indicate reference characteristics for the HDR and/or SDR video. The reference characteristics may be with respect to a reference HDR or SDR grading monitor.

In an embodiment, brightness, contrast, and/or color primaries of a reference HDR grading monitor may be included in metadata (e.g., the metadata 244) provided with the HDR video (e.g., the video 242) that is input to the player system 200. That is, the HDR video may have been subject to color processing according to techniques that are optimized for viewing conditions that are represented by the HDR metadata. The controller 210 may compare the conditions identified by the metadata to conditions identified by the sensor 230 to determine correction factors to be applied to the HDR video prior to output to the display 220.

According to an embodiment, the set of metadata included with the video may be expanded to include additional HDR background illumination levels, including diffused light level and/or angular incidence light measurements. The metadata also may include additional HDR background lighting chromaticity and additional information about HDR screen size and maximal viewing angle relative to normal. The metadata further may include additional information about HDR screen resolution and/or screen video processing, such as spatial scaling and chroma subsampling. The metadata yet further may include additional information regarding viewing distance and additional information regarding types of processing performed on source video, such as spatial scaling, chroma scaling, and the like. During rendering, the controller 210 may compare these elements defining a reference grading environment to actual viewing conditions and may alter display mapping operations accordingly.

As indicated, the mapping operation performed by the controller 210 may leverage the above reference characteristics to improve the viewing quality of the video 242 when rendered and transmitted to one or more of the displays 220, 260 as a video drive signal. For example, the controller 210 may compare the above reference characteristics defining the reference grading environment to the actual viewing conditions in which the display(s) 220, 260 are located and operate. Based on this comparing, the controller 210 may render the video drive signal accordingly. As another example, the controller 210 may compare the above reference characteristics of the reference grading environment to display characteristic of the HDR display.

The mapping operation performed by the controller 210 may be yet further improved with additional consideration to SDR grading monitor reference information and for reference grading environment information. For example, given information indicating a viewing ambient light level, the mapping operation performed on HDR video can result in an output brightness and/or contrast that is not lower than that of an SDR grading environment.

The SDR grading monitor reference information may be included in the metadata 244 provided by the video source 240 to the controller 210. As some examples, the SDR grading monitor characteristics may include SDR display minimum and maximum brightness, SDR display color primaries, SDR background illumination level (e.g., diffused light level and/or angular incidence light measurement). The SDR grading monitor characteristics may include SDR background lighting chromaticity, as well as information indicating SDR screen size and/or maximal viewing angle relative to normal. The SDR grading monitor characteristics further may include information indicative of SDR screen resolution, and/or any monitor video processing, such as spatial scaling and chroma subsampling. The SDR grading monitor characteristics may include information indicating SDR average brightness, SDR peak brightness, and/or SDR brightness of a region-of-interest.

The controller 210 may be realized in the form of a computing device, which may comprise a processor and a memory. The memory may store instructions that, when executed by the processor, effectuate various operations described herein. As some examples, the controller 210 may comprise a mobile device (e.g., a smart phone or tablet computer), a personal computer, a set-top box, a digital media player, or other type of computing device capable of generating a video drive signal to a display.

The controller 210 may provide logic used to implement the mapping and other techniques described herein. The controller 210 may be realized in hardware or software form, or a combination of the two. As indicated, the controller 210 may generate video drive signals from HDR source video, including HDR video 242 and HDR metadata 244. The video drive signals may be tailored for the display 220, which are described in the display characteristics memory system 250, taking into account ambient brightness or other environmental characteristics as reported by the sensor 230. Additionally, the controller 210 may alter its mapping operation based on consideration of SDR source data and/or characteristics of a second display 280, as described herein.

The display characteristics stored in the display characteristics memory system 250 may include brightness attributes of the relevant HDR or SDR display. A brightness attribute may include a maximum brightness, a minimum brightness, an average brightness, or a brightness contrast. As another example, the display characteristics may include a color attribute of the relevant HDR or SDR display. The color attribute may include a color depth or color space. In addition, the characteristics described above with respect to the HDR or SDR reference grading monitor may be included in the display characteristics, and vice versa. The display characteristics of the HDR and/or SDR monitor may be used in the mapping operation performed by the controller 210 so as to take account of the actual display that will present the video drive signal.

The sensor 230 may comprise, for example, a light sensor configured to measure the brightness of the ambient environment in which the display 220 and/or the display 260 are located. As another example, the sensor 230 may be configured to detect the color of the light in the ambient environment. While the sensor 230 is generally described as part of or connected to the player 205, in some embodiments the sensor 230 may be discrete from the player 205. For example, the sensor 230 may be incorporated as part of the display 220 or display 260.

The video 242 and/or metadata 244 may be provided to the controller 210 via a channel 270 comprising, at least in part, a network 275. The network 275 may be embodied as a wireless network, a wired network, or a combination thereof. For example, a wired network may comprise an Ethernet network. An example of a wireless network may include a cellular network or a WiFi network. Unless otherwise indicated, the precise embodiment of the network 275 is immaterial to the present disclosure.

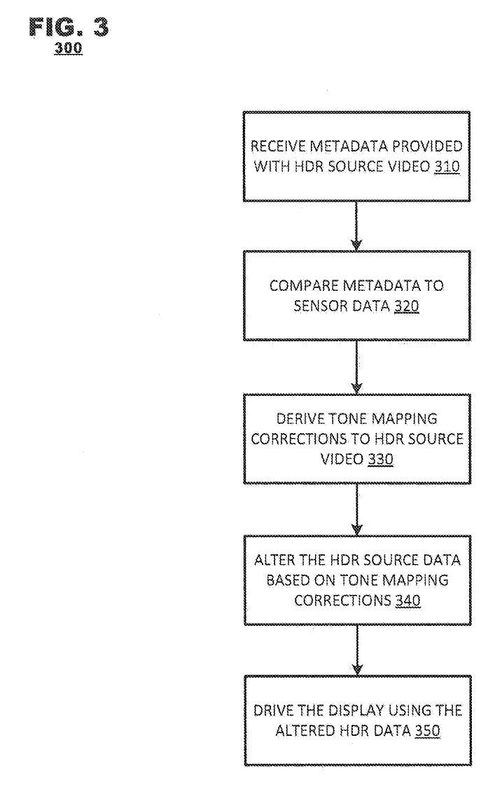

FIG. 3 illustrates an example method 300 of processing video for display. Initially, metadata is received that is provided with HDR source video data. (box 310). The metadata is then compared to sensor data representing viewing conditions at a display device (box 320). Tone mapping corrections to the HDR source video may be derived from the comparison of the metadata to the sensor data (box 330). The HDR source video data may be altered based on the tone mapping corrections (box 340). Thereafter, the altered HDR source video data may be used to drive the display device (box 350).

As an example, the viewing conditions may represent a brightness at the location of the display device. As another example, the viewing conditions may represent a color of light at the location of the display device. The viewing conditions may be measured by a sensor associated with the display device.

The metadata may comprise reference characteristics of a reference grading monitor, such as a reference HDR or. SDR grading monitor. The reference characteristics may include, as some examples, brightness, contrast, and/or color primaries of the reference HDR or SDR grading monitor. Other example characteristics are described herein.

The tone mapping corrections may be further based on a display characteristic of the display device. The tone mapping corrections may further comprise comparing the metadata one or more display characteristics of the display device. For example, a display characteristic may include a maximum brightness or other brightness attribute, a color depth, a color space, or other display characteristics provided herein.

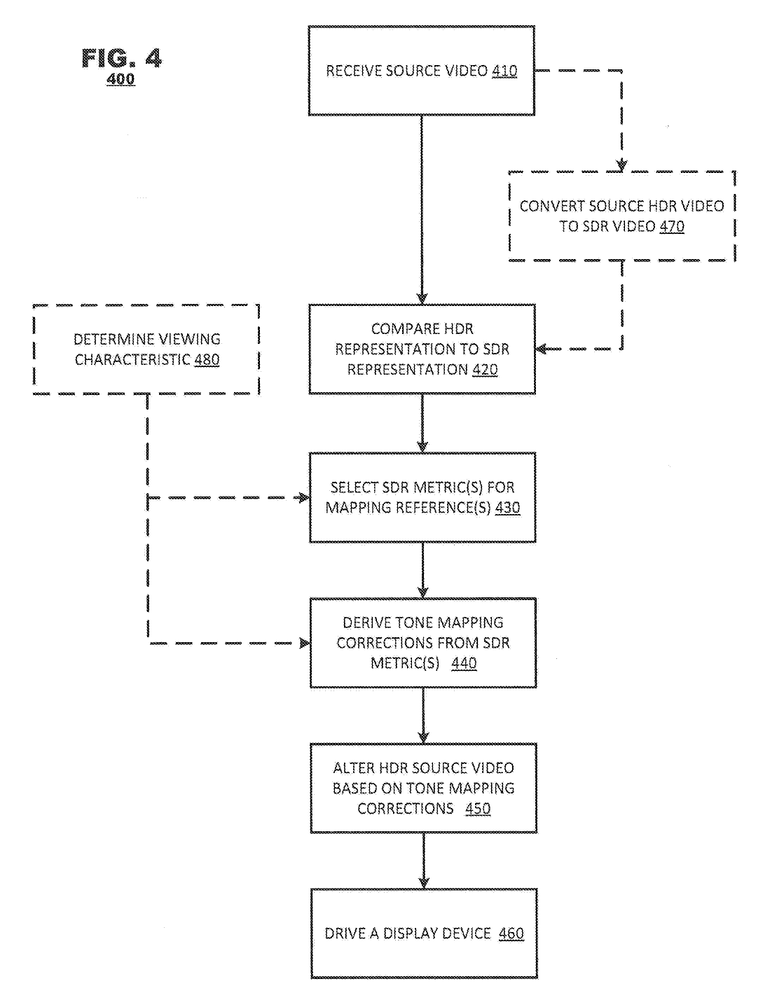

FIG. 4 illustrates an example method 400 for mapping HDR video to improve view quality of the HDR video. The method 400 may receive source HDR video and, optionally, HDR metadata, as described herein (box 410). The HDR representation of the source video may be compared to an SDR representation of the source video (box 420). Based on this comparison, one or more SDR metrics may be selected for use as mapping reference(s) (box 430). Tone mapping corrections to the HDR source video may be derived from the selected SDR metrics (box 440). The HDR source video may be altered based on the tone mapping corrections (box 450). Finally, the altered HDR source video may be used to drive a display device (box 460). Optionally, if the SDR representation of the source video is not available, it may be obtained by converting the HDR representation to the SDR representation (box 470). Also optionally, a viewing environment characteristic may be determined (box 480) and thereby used in selecting the SDR metric(s) for mapping reference(s) and/or deriving the tone mapping corrections.

The method 400 may be implemented within the context of a viewing environment with two (or more) displays, such as that illustrated in FIG. 1(b). For example, one of the displays may be an HDR display and the other may be an SDR display. The HDR display may be configured to display the full dynamic range of brightness contrast (e.g., a peak brightness and the minimum or “black level” brightness) and/or color provided in HDR video. The SDR display may be configured to only display limited brightness contrast and/or color compared to an HDR display. The HDR display and the SDR display may be located at a common location and may be within a common field of perception of a viewer. In one embodiment, the display device driven using the altered HDR source video may be an HDR display. Further, the SDR source video may be used to drive an SDR display.

The method 400 may also find use in the context of a single display and wherein the source video comprises both HDR and SDR video, as seen in FIG. 1(a). For example, the source video may contain a number of segments of HDR video followed by a number of segments of SDR video. By altering the HDR portions of the source video based on SDR metrics of the SDR metrics, of the source video, the shifts between the HDR portions and the SDR may be less perceptible to a viewer.

The HDR video and the SDR video may comprise common video content. By selecting SDR metrics and using those selected SDR metrics, the HDR source video may be mapped so that the display of the mapped HDR video on the HDR display may be visually similar to the display of the SDR video on the SDR display. For example, even though the HDR display is capable of displaying a range of brightness greater than that of the SDR display and/or the average or peak brightness of the video content of the SDR video, the HDR video may be mapped to adjust a brightness characteristic of the HDR video as it is expected to be actually displayed on the HDR display and to match the actual display of the SDR video on the SDR display.

As indicated, the selection of the SDR metric for use as a mapping metric and/or the mapping operation of the HDR source video itself may be performed further based on a determined viewing characteristic of the ambient environment in which the HDR and SDR displays may be located. For example, the viewing characteristic may include the brightness of the ambient environment. As another example, the viewing characteristic may include the color of the light present in the environment, such as that produced by a fluorescent light bulb versus the color of light produced by an incandescent light bulb.

For example, the average/peak brightness of SDR video and/or the brightness of a region-of-interest of SDR video may he selected as a mapping reference. This can also he done during playback if the player has enough computing power to handle the additional down mapping.

In an example, the one or more SDR metrics selected for use as mapping reference(s) may be further based, on a characteristic of an actual visual display of the HDR video and/or the SDR video. For example, the one or more SDR metrics selected for use as mapping reference(s) may be further based on a comparison of a characteristic of the visual display of the HDR video and a corresponding characteristics of the visual display of the SDR video. It is noted that the visual display of the HDR video and the visual display of the SDR video may occur on separate display devices or the same display device.

In an example, the mapping references used to map the HDR source video may be further based on metadata provided in conjunction with the HDR and/or SDR source video. As indicated above, the metadata may comprise reference characteristics of a reference HDR or SDR grading environment, it characteristics of a reference HDR or SDR grading monitor.

In another example, the mapping references selected to map the HDR source video according to one or more characteristics of the HDR and/or SDR display to which the respective rendered source video will be transmitted and on which it will be displayed. The characteristics of the HDR and/or SDR display may be stored in and retrieved from the display characteristic memory system 250 of FIG. 1(a-b). As an example, the characteristics of the HDR display may indicate a maximum brightness of the HDR display. The HDR source video may be mapped based on this maximum brightness.

As another example, an HDR display and an SDR display may differ in their capacity to display a video having a particular chromaticity profile, with the HDR display being able to display a broader chromaticity profile and the SDR display being limited to a narrower chromaticity profile.

In yet another example, a viewing characteristic of the HDR and SDR displays' environment may be compared to a corresponding characteristic of a reference grading environment, such as that included in the metadata provided in associated with the HDR and/or SDR source video. The mapping, of the HDR source video additionally may be performed according to this comparison.

In yet another example, the mapping of the HDR source video may be performed according to a comparison of a characteristic of a reference HDR grading environment with a corresponding characteristic of the HDR display upon which the display content is to be presented.

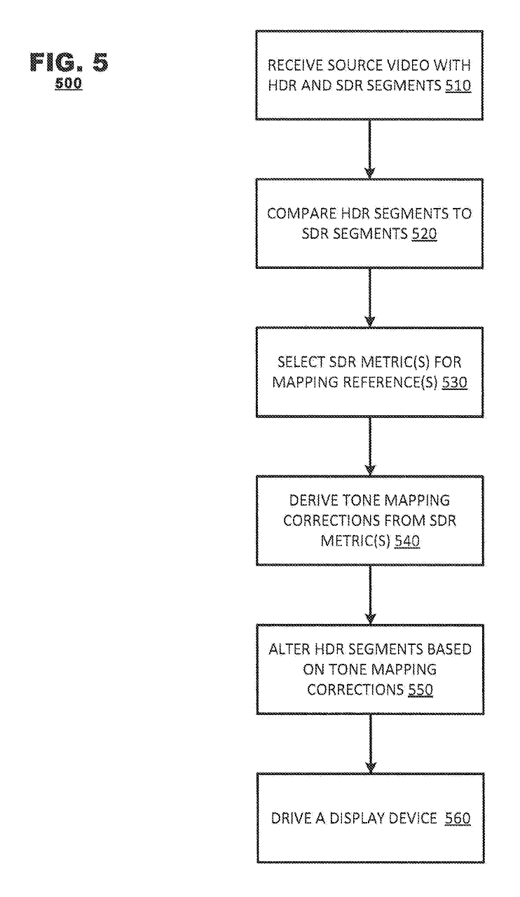

FIG. 5 illustrates another example method 500 for mapping HDR video to improve viewing quality of the HDR video. The method 500 may be implemented within the context of a single display, which may be an SDR or an HDR display. Such an arrangement is portrayed in FIG. 1(a).

Initially, the method 500 may receive source video data comprising HDR segments (or other apportionment) and SDR segments (or other apportionment) (box 510). The HDR segments and the SDR segments may be compared with one another (hex 520). Based on this comparison, the method 500 may select one or more SDR metrics for use as mapping references (box 530). Tone mapping corrections to the HDR segments may be derived from the selected SDR metrics (box 540). The HDR segments may be altered based on the tone mapping corrections (box 550). Thereafter, the altered HDR segments may he used to drive a display device (box 560).

In one example, the display device may be an HDR display. Further, the display device may be a display of a terminal device, such as a mobile device.

The HDR segments and the SDR segments may be ordered sequentially in the source video data. For example, the HDR segments may directly follow the SDR segments in the source video data, or vice versa. The HDR segments and the SDR segments may be common video content or may be different video content. By mapping the HDR segments according to the SDR metrics based on the comparison of the HDR segments to the SDR segments, the resultant altered HDR segments may exhibit similar visual characteristics as the preceding (or following, as the case may be) SDR segments. Accordingly, the switch between the HDR segments and the SDR segments may be less noticeable to a viewer than it would be otherwise.

A viewing characteristic of the ambient environment in which the display is located may be optionally used in selecting the SDR metric fir use as a mapping reference and/or determining the tone mapping corrections. The ambient viewing characteristic may indicate, for example, a brightness of the ambient environment of the display device.

The metadata associated with the source video data may form a further basis for selecting mapping references by which the tone mapping corrections to the HDR segments are derived. The metadata may comprise reference characteristics of a reference HDR or SDR grading environment. The reference grading environment may include a reference HDR or SDR grading monitor.

The tone mapping corrections to the HDR segments may be further based on a characteristic of the display on which the display content will be presented. Such display characteristics may include, for example, a brightness contrast, an available color range, or other display characteristic described herein.

The reference grading environment and the ambient viewing characteristics may be used ire conjunction by comparing corresponding characteristics of each with one another. The HDR segments may be mapped according to this comparisons. Similarly, the mapping the HDR segments may be based on a comparison of a characteristic of the reference grading environment with a corresponding characteristic of the display device.

The following alternative and/or optional embodiments may find application in relation to the method 300, the method 400, the method 500, or any other method or technique described herein.

In an embodiment, when the SDR source is not available, the method may apply SDR-aware tone mapping learned from other video assets (step not shown). This technique may apply a learning-based approach because tone mapping may be developed iteratively from other assets, which may be applied for new HDR video that is received.

In an embodiment, mapping may be performed on a genre-specific basis. HDR content may be assigned a genre (e.g., cartoon, western, etc.) which may have content characteristics associated with it. Genre-specific mappings may be developed, which may be applied to new HDR content when a match is identified between a genre assigned to the HDR content and a genre to which the mappings are assigned.

In another embodiment, metadata may be included to control player video post-processing techniques. For example, player devices often perform filtering operations and other enhancements to counteract artifacts that might be introduced by data compression/decompression operations. Metadata may be included in a video stream to control how much post-processing may be performed by a player and which types of post-processing operations may be performed.

In an embodiment, display backlight levels can be adjusted for HDR video if video content does not need the maximum brightness for certain scenes. This will reduce backlight leakage and improve viewing experience for dark scenes. Alternatively, backlight level adjustments may be performed even for video content that requires full backlight power. In such embodiments, a controller may estimate portions of video that contain large amounts of black content as compared to bright content. For content with relatively large proportions of black content, backlight levels may be reduced. Doing so may reduce backlight leakage at the expense of reduced brightness for bright portions (for example, highlights) of image content.

In an embodiment, a player may invoke a playback mode that reduces black bars used in rendering, for example, letterbox format video and the like. A player may zoom and/or crop content to remove such black bars or display something other than black bars, which avoids leakage events and may contribute to an improved viewing experience.

In an embodiment, video metadata may include indicators of backlight brightness, which may be used by a player directly to manage backlight brightness. Metadata also may include additional tone curves to manage display mapping processes at the reduced brightness levels.

In an embodiment metadata brightness indicators may be provided by an author of video content, which may be provided to a player along with displayable video data. In another embodiment, metadata brightness indicators may be derived during video coding/compression operations, which may be performed after an author has completed work developing the source video. Such coding/compression operations typically exploit spatial and/or temporal redundancies in video content to achieve data compression. Brightness indicators may be derived from content analyses of source video content as the video coding/compression operations are performed.

In an embodiment, the methods described herein may be applied to map SDR video in an analogous manner as that described to map HDR video. For example, a method may comprise comparing an SDR representation (or segments) of source video to an HDR representation (or segments) of the source video. Based on this comparison, one or more HDR metrics may be selected for use as mapping reference(s). Tone mapping corrections to the SDR representation may be derived from the selected from the selected HDR metrics. The SDR source video may be altered based on the tone mapping corrections. The display device may be driven using the altered SDR source video data.

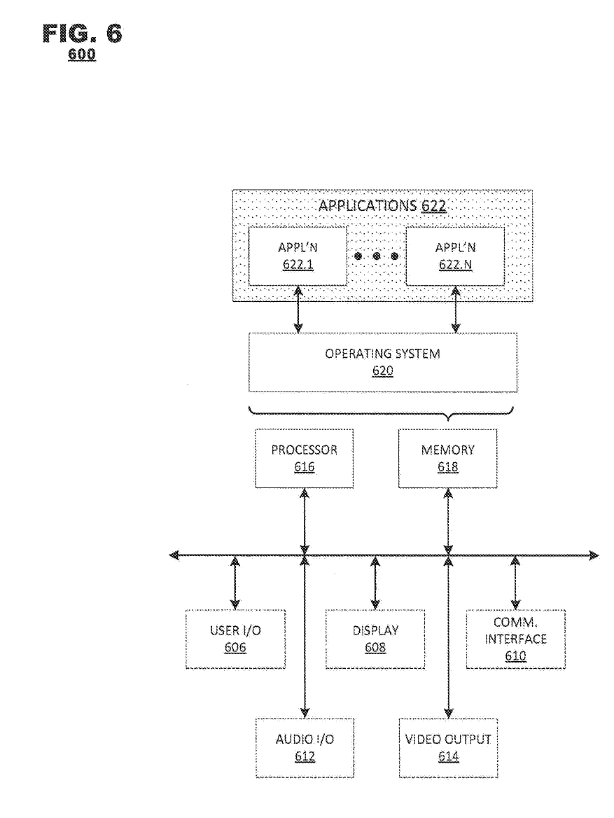

FIG. 6 is a block diagram of a computing device 600 according to an embodiment of the present disclosure. The computing device 600 may implement any of the systems and components of the present disclosure, including, but not limited to, the terminal 110 of FIG. 1(a-b) and the controller 210 of FIG. 2. It is contemplated that multiple computing devices 600 may act in conjunction to implement any of the systems or methods described herein.

The computing device 600 may include a processor 616 and a memory 618. The memory 648 may store instructions that, when executed by the processor 616, effectuate any of the methods and techniques described herein. Further, the memory 618 may store program instructions that define an operating system 620 and various applications 622 that are executed by the processor 616. The applications 622 may include a number of applications 622.1-622.N. The applications 622 may comprise, for example, the controller 210 of FIG. 2. The memory 618 may also store application data for any of the applications 622.

The computing device 600 may include a communication interface 610 by which the computing device 600 may receive or transmit data, including, video source data. The communication interface 610 may be realized in the form of a transceiver configured for wireless communication, such as WiFi or cellular communication. The communication interface 610 additionally or alternatively may be realized in the form of a network interface configured for wired communication. The network interface may comprise an Ethernet interface, for example.

The computing device 600 also illustrates other components that may be common to computing devices used to implement the systems and methods described herein. The computing device 600 may include one or more optional components depending on the particular implementation of the described systems and methods. For example, a player may be embodied as a device dedicated primarily to video processing and outputs the processed video for display by a separate display device. Such a dedicated device may include a set-top box or a digital media player, as some examples. Yet a player alternatively may be embodied as a device incorporating a display by which the processed video is presented. This type of device may include a terminal, such as a smart phone, tablet computer, or a laptop.

The computing device 600 may include an audio input/output 612. The audio input/output 612 may include a microphone, a speaker, or a wired audio interface. The computing device 600 may include a user input/output 606, such as a pointing device, a keyboard, or a touch-sensitive display, particularly in terminal form. In a dedicated video processor form of the computing device 600, the user input/output 606 may include a remote control. The computing device 600 further may comprise a video output 614. In a dedicated video processor form of the computing device 600, the video output 614 may comprise a wired video output, such as an HDMI interface.

In embodiments in which the computing device 600 is realized in a terminal form (e.g., a mobile device, etc.), the computing device 600 may include a display 608 incorporated therewith. For example, smart phones and tablet computers both incorporate a display 608. Thus, the computing device 600 may both perform the various video processing methods and techniques described herein as well as present the video to the viewer.

The various systems, methods, and techniques described herein may be implemented in software, such as one or more of the applications 622 of the computing device. Additionally or alternatively, the systems, methods, and techniques described herein may be implemented in dedicated hardware components such as application specific integrated circuits, field programmable gate arrays and/or digital signal processors. Further, these components may be provided as hybrid systems that distribute functionality across dedicated hardware components and programmed general purpose processors, as desired.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A method of processing video for display:
responsive to metadata provided with HDR (high dynamic range) source video data, comparing the received metadata to sensor data representing viewing conditions at a display device;
deriving tone mapping corrections to the HDR source video data from the comparison of the received metadata to the sensor data;
altering the HDR source video data based on the tone mapping corrections; and
driving the display device using the altered HDR source video data.

2. The method of claim 1, wherein the display device is an HDR display.

3. The method of claim 1, wherein the viewing conditions at the display device comprise a brightness of an ambient environment of the display device,

4. The method of claim 1, wherein the viewing conditions at the display device comprise a color attribute of light in an ambient environment of the display device,

5. The method of claim 1, wherein the received metadata comprises a characteristic of a reference HDR grading monitor.

6. The method of claim 5, wherein the characteristic of the reference HDR grading monitor comprises at least one of a brightness attribute, a contrast attribute, color primaries, an HDR background illumination level, an HDR background lighting chromacity, an HDR screen size, a maximal viewing angle relative to normal, an HDR resolution, a spatial scaling, a chroma subsampling, and a backlight brightness level.

7. The method of claim 1, wherein the tone mapping corrections are further derived based on a comparison of a characteristic of a reference HDR grading monitor represented in the metadata with a corresponding characteristic of the display device.

8. The method of claim 1, wherein the deriving further comprises:
comparing the HDR source video to an SDR (standard dynamic range) representation of the source video;
based on the comparison, selecting one or more SDR metrics for use as mapping reference(s); and
deriving the tone mapping corrections to the HDR representation based in part on the selected SDR metric(s).

9. A method of mapping HDR (high dynamic range) source video, the method comprising:
comparing an HDR representation of a source video to an SDR (standard dynamic range) representation of the source video;
based on the comparison, selecting one or more SDR metrics for use as mapping reference(s);
deriving tone mapping corrections to the HDR representation from the selected SDR metric(s);
altering the HDR representation based on the tone mapping corrections, and driving a display device using the altered HDR representation.

10. The method of claim 9, wherein the SDR representation and the HDR representation are received from a common video source.

11. The method of claim 9, wherein the SDR representation is obtained by converting the HDR representation to the SDR representation.

12. The method of claim 9, wherein the display device comprises an HDR display.

13. The method of claim 12, further comprising:
driving a second display device using the SDR representation, wherein the second display device comprises an SDR display.

14. The method of claim 13, wherein the display device and the second display device are located at a common location.

15. The method of claim 9, wherein the tone mapping corrections to the HDR representation are further based on an ambient viewing condition of the display device.

16. The method of claim 15, wherein the ambient viewing condition comprises a brightness of an environment of the HDR display.

17. The method of claim 9, wherein the tone mapping corrections to the HDR representation are further based on a characteristic of a reference HDR grading monitor.

18. The method of claim 17, wherein the characteristic of the reference HDR grading monitor comprises at least one of a brightness attribute, a contrast attribute, color primaries, an HDR background illumination level, an HDR background lighting chromacity, an HDR screen size, a maximal viewing angle relative to normal, an HDR resolution, a spatial scaling, a chroma subsampling, and a backlight brightness level.

19. The method of claim 9, wherein the tone mapping corrections to the HDR representation, are further based on a comparison of a characteristic of a reference HDR grading monitor and a corresponding characteristic of an ambient viewing condition of the display device.

20. The method of claim 9, wherein the tone mapping corrections to the HDR representation are further based on a comparison of a characteristic of a reference HDR grading monitor and a corresponding characteristic of the display device.

21. The method of claim 9, wherein the tone mapping corrections to the HDR source video are further based on a characteristic of a reference SDR grading monitor.

22. The method of claim 21, wherein the characteristic of the reference SDR grading monitor comprises at least one of a brightness attribute, a contrast attribute, color primaries, an SDR background illumination level, an SDR background lighting chromacity, an SDR screen size, a maximal viewing angle relative to normal, an SDR resolution, a spatial scaling, a aroma subsampling, and a backlight brightness level.

23. The method of claim 9, wherein the tone mapping corrections to the HDR representation are further based on a genre of the source video.

24. The method of claim 9, wherein the HDR representation and the SDR representation represent common video content.

25. The method of claim 9, wherein the selecting the one or more SDR metrics for use as mapping reference(s) may be further based on a characteristic of a visual display of the 1-HDR source video and a corresponding characteristic of a visual display of the SDR source video.

26. A method of mapping HDR (high dynamic range) source video, the method comprising:
comparing HDR segments of a source video to SDR (standard dynamic range) segments of the source video;
based on the comparison, selecting one or more SDR metrics for use as mapping reference(s);
deriving tone mapping corrections to the HDR segments from the selected SDR metric(s) altering the HDR segments based on the tone mapping corrections; and
driving a display device using the altered HDR segments.

27. The method of claim 26, further comprising:
wherein the display device comprises an HDR display.

28. The method of claim 26, wherein the HDR segments immediately precede or follow the SDR segments.

29. The method of claim 26., wherein the HDR segments and the SDR segments represent common video content.

30. The method of claim 26, wherein the tone mapping corrections to the HDR segments are further based on an ambient viewing condition of the display device.

31. The method of claim 30, wherein the ambient viewing condition comprises a brightness of an environment of the display device.

32. The method of claim 26, wherein the tone mapping corrections to the HDR segments are further based on a characteristic of a reference HDR grading monitor.

33. The method of claim 32, wherein the characteristic of the reference HDR grading monitor comprises at least one of a brightness attribute, a contrast attribute, color primaries, an HDR background illumination level, an HDR background lighting chromacity, an HDR screen size, a maximal viewing angle relative to normal, an HDR resolution, a spatial scaling, a chroma subsampling, and a backlight brightness

34. The method of claim 26, wherein the tone mapping corrections to the HDR segments are further based on a comparison of a characteristic of a reference HDR grading monitor and a corresponding characteristic of an ambient viewing condition of the display device.

35. The method of claim 26, wherein the tone mapping corrections to the HDR segments are further based on a comparison of a characteristic of a reference HDR grading monitor and a corresponding characteristic of the display device.

36. The method of claim 26, wherein the tone mapping corrections to the HDR segments are further based on a characteristic of a reference SDR grading monitor.

37. The method of claim 36, wherein the characteristic of the reference SDR grading monitor comprises at least one of a brightness attribute, a contrast attribute, color primaries, an SDR background illumination level, an SDR background lighting chromacity, an SDR screen size, a maximal viewing angle relative to normal, an SDR resolution, a spatial scaling, a chroma subsampling, and a backlight brightness level.

38. The method of claim 26, wherein the tone mapping corrections to the HDR segments are further based on a genre of the HDR segments.

39. The method of claim 26, wherein the tone mapping corrections to the HDR segments may be further derived from a characteristic of a visual display of the HDR segments and a corresponding characteristic of a visual display of the SDR segments.

40. A computer-readable medium storing data that, when executed by a processor, effectuate operations to process video for display, the operations comprising:
responsive to metadata provided with an HDR (high dynamic range) source video data, comparing the received metadata to sensor data representing viewing conditions at a display device;
deriving tone mapping corrections to the HDR source video data from the comparison of the received metadata to the sensor data;
altering the HDR source video data based on the tone mapping corrections; and
driving the display device using the altered HDR source video data.

41. A computing device, comprising:
a processor; and
a memory system in mutual communication with the processor, wherein the memory system stores data that, when executed by the processor, cause the processor to effectuate operations to process video for display, the operations comprising:
responsive to metadata provided with an HDR (high dynamic: range) source video data, comparing the received metadata to sensor data representing viewing conditions at a display device;
deriving tone mapping corrections to the HDR source video data from the comparison of the received metadata to the sensor data;
altering the HDR source video data based on the tone mapping corrections; and
driving the display device using the altered HDR source video data.
